(19) United States
(12) Patent Application Publication
(10) Pub. No.: US 2011/0125734 A1
(43) Pub. Date: May 26, 2011

(54) QUESTIONS AND ANSWERS GENERATION

(75) Inventors: Pablo A. Duboue, White Plains, NY (US); David A. Ferrucci, Yorktown Heights, NY (US); David C. Gondek, Astoria, NY (US); James W. Murdock, IV, Hartsdale, NY (US); Wlodek W. Zadrozny, Tarrytown, NY (US)

(73) Assignee: INTERNATIONAL BUSINESS MACHINES CORPORATION, Armonk, NY (US)

(21) Appl. No.: 12/724,156

(22) Filed: Mar. 15, 2010

Related U.S. Application Data
(60) Provisional application No. 61/263,561, filed on Nov. 23, 2009.

(51) Int. Cl. G06F 17/30

(52) U.S. Cl. 707/723; 707/E17.044; 707/803; 707/769; 707/E17.014; 707/722

(57) ABSTRACT

A system, method and/or computer program product for automatically generating questions and answers based on any corpus of data. The computer system, given a collection of textual documents, automatically generates collections of questions about the documents together with answers to those questions. In particular, such a process can be applied to the so called ‘open’ domain, where the type of the corpus is not given in advance, and neither is the ontology of the corpus. The system improves the exploring of large bodies of textual information. Applications implementing the system and method include new types of tutoring systems, educational question-answering games, national security and business analysis systems, etc.

### CROSS-REFERENCE TO RELATED APPLICATIONS

The present invention claims the benefit of U.S. Provisional Patent Application No. 61/263,561 filed on Mar. 15, 2009, the entire contents and disclosure of which is expressly incorporated by reference herein as if fully set forth herein. The present invention is also related to the following commonly-owned, co-pending United States Patent Applications, the entire contents and disclosure of each of which is expressly incorporated by reference herein as if fully set forth herein: U.S. patent application Ser. No. 12/126,642, for “SYSTEM AND METHOD FOR PROVIDING QUESTION AND ANSWERS WITH DEFERRED TYPE EVALUATION”; U.S. patent application Ser. No. 12/152,411, for “SYSTEM AND METHOD FOR PROVIDING ANSWERS TO QUESTIONS”.

### BACKGROUND

The present invention generally relates to information retrieval systems, and more particularly, the invention relates to a novel query/answer generation system and method implementing a degree of parallel analysis for enabling the generation of question-answer pairs based on generating and quickly evaluating many candidate answers.

An introduction to the current issues and approaches of Questions Answering (QA) can be found in the web-based reference http://en.wikipedia.org/wiki/Question_answering. Generally, question answering is a type of information retrieval. Given a collection of documents (such as the World Wide Web or a local collection) the system should be able to retrieve or construct (e.g. when two facts are present in different documents and need to be retrieved, syntactically modified, and put in a sentence) answers to questions posed in natural language. QA is regarded as requiring more complex natural language processing (NLP) techniques than other types of information retrieval such as document retrieval, and it is sometimes regarded as the next step beyond search engines.

QA research attempts to deal with a wide range of question types including: fact, list, definition, How, Why, hypothetical, semantically-constrained, and cross-lingual questions, Search collections vary from small local document collections, to internal organization documents, to compiled newswire reports, to the world wide web.

Closed-domain question answering deals with questions under a specific domain (for example, medicine or automotive maintenance), and can be seen as an easier task because NLP systems can exploit domain-specific knowledge frequently formalized in ontologies. Open-domain question answering deals with questions about nearly everything, and can only rely on general ontologies and world knowledge. On the other hand, these systems usually have much more data available from which to extract the answer.

Alternatively, closed-domain might refer to a situation where only a limited type of questions are accepted, such as questions asking for descriptive rather than procedural information.

Access to information is currently dominated by two paradigms: a database query that answers questions about what is in a collection of structured records; and, a search that delivers a collection of document links in response to a query against a collection of unstructured data (text, html etc.).

One major unsolved problem in such information query paradigms is the lack of a computer program capable of answering factual questions based on information included in a large collection of documents (of all kinds, structured and unstructured). Such questions can range from broad such as “what are the risk of vitamin K deficiency” to narrow such as “when and where was Hillary Clinton's father born”.

User interaction with such a computer program could be either single user-computer exchange or multiple turn dialog between the user and the computer system. Such dialog can involve one or multiple modalities (text, voice, tactile, gesture etc.). Examples of such interaction include a situation where a cell phone user is asking a question using voice and is receiving an answer in a combination of voice, text and image (e.g. a map with a textual overlay and spoken (computer generated) explanation. Another example would be a user interacting with a video game and dismissing or accepting an answer using machine recognizable gestures or the computer generating tactile output to direct the user.

The challenge in building such a system is to understand the query, to find appropriate documents that might contain the answer, and to extract the correct answer to be delivered to the user. Currently, understanding the query is an open problem because computers do not have human ability to understand natural language nor do they have common sense to choose from many possible interpretations that current (very elementary) natural language understanding systems can produce.

### SUMMARY

The present invention describes a system, method and computer program product that leverages the existence of large bodies of text (e.g., a corpus) encoding/describing the domains of knowledge to explore through questions (and answers) and leverage to create applications such as tutoring system or games. In one aspect, the system and method do not require predefined sets of question/answer pair (or patterns). Advantageously, the system, method and computer program product applies natural language dialog to explore open domains (or more broadly corpora of textual data) through, e.g., tutorial dialogs or games, based on automatically extracted collections of question-answer pairs.

Thus, in a first aspect, there is provided a system for question-answer list generation comprising: a memory device; and a processor connected to the memory device, wherein the processor performs steps of: generating, from a corpus of text data and a set of criteria, one or more data structures; generating, based on the set of criteria and one or more data structures, an initial set of questions; retrieving a set of documents based on the initial set of questions; generating from the documents, candidate question and answers; conforming the set of candidate questions and answers to satisfy the set of criteria; analyzing a quality of answers of the conformed set of questions and answers; generating further one or more answers based on the analyzing; and, outputting, based on the further one or more answers and the criteria, a final list question-answer (QA) pairs, wherein a program using a processor unit executes one or more of the generating, retrieving, generating, conforming, analyzing, generating and outputting.

In a further aspect, the conforming comprises pruning and/or modifying the set of answers and questions to satisfy the criteria.

In accordance with a further aspect, there is provided a computer-implemented method for generating questions and answers pairs based on any corpus of data, the method comprising: generating, from a corpus of text data and a set of criteria, one or more data structures; generating, based on the set of criteria and one or more data structures, an initial set of questions; retrieving a set of documents based on the initial set of questions; generating from the documents, candidate question and answers; conforming the set of candidate questions and answers to satisfy the set of criteria; analyzing a quality of answers of the conformed set of questions and answers; generating further one or more answers based on the analyzing; and, outputting, based on the further one or more answers and the criteria, a final list question-answer (QA) pairs, wherein a program using a processor unit executes one or more of the generating, retrieving, generating, conforming, analyzing, generating and outputting.

A computer program product is for performing operations. The computer program product includes a storage medium readable by a processing circuit and storing instructions run by the processing circuit for running a method. The method is the same as listed above.

Advantages, objects and embodiments will be further explored in the following discussion.

### BRIEF DESCRIPTION OF THE DRAWINGS

The objects, features and advantages of the invention are understood within the context of the Description of the Preferred Embodiment, as set forth below. The Description of the Preferred Embodiment is understood within the context of the accompanying drawings, which form a material part of this disclosure, wherein:

FIG. 1 shows a system diagram depicting a high level logical system architecture for generating QA pairs based on a corpus of data;

FIG. 2A shows illustrates a high-level architecture of a question/answering (QA) sub-system module 100 and method implemented in the system of FIG. 1, and FIG. 2B shows a more detailed diagram for Evidence Gathering element including two sub-modules: Supporting Passage Retrieval and Candidate Answer Scoring that provide candidate answer score and ranking processing;

FIGS. 3A and 3B illustrate a flow chart depicting the methodology for question-answer pair generation;

FIG. 4 illustrates a variant of the architecture of FIG. 1 adapted for tutoring and/or gaming including an interface between the QA sub-system 100 and a game/tutoring server element 150 according to one embodiment;

FIG. 5 illustrates an Open Domain Gaming system 500 according to one embodiment;

FIG. 6 illustrates a collaborative or competitive interactive gaming system 600 partitionable to accommodate teams of users that can interact with the Open Domain Gaming System 500 of FIG. 5;

FIG. 7 illustrates a confidence meter 700 employed in the gaming/tutoring systems of FIG. 4-6; and,

FIG. 8 illustrates an exemplary hardware configuration for implementing the methodology depicted in FIGS. 3A, 3B in one embodiment.

### DETAILED DESCRIPTION

As will be referred to herein, the word “question” and “query,” and their extensions, are used interchangeably and refer to the same concept, namely request for information. Such requests are typically expressed in an interrogative sentence, but they can also be expressed in other forms, for example as a declarative sentence providing a description of an entity of interest (where the request for the identification of the entity can be inferred from the context). “Structured information” (from “structured information sources”) is defined herein as information whose intended meaning is unambiguous and explicitly represented in the structure or format of the data (e.g., a database table). “Unstructured information” (from “unstructured information sources”) is defined herein as information whose intended meaning is only implied by its content (e.g., a natural language document). By “Semi structured” it is meant data having some of the meaning explicitly represented in the format of the data, for example a portion of the document can be tagged as a “title”.

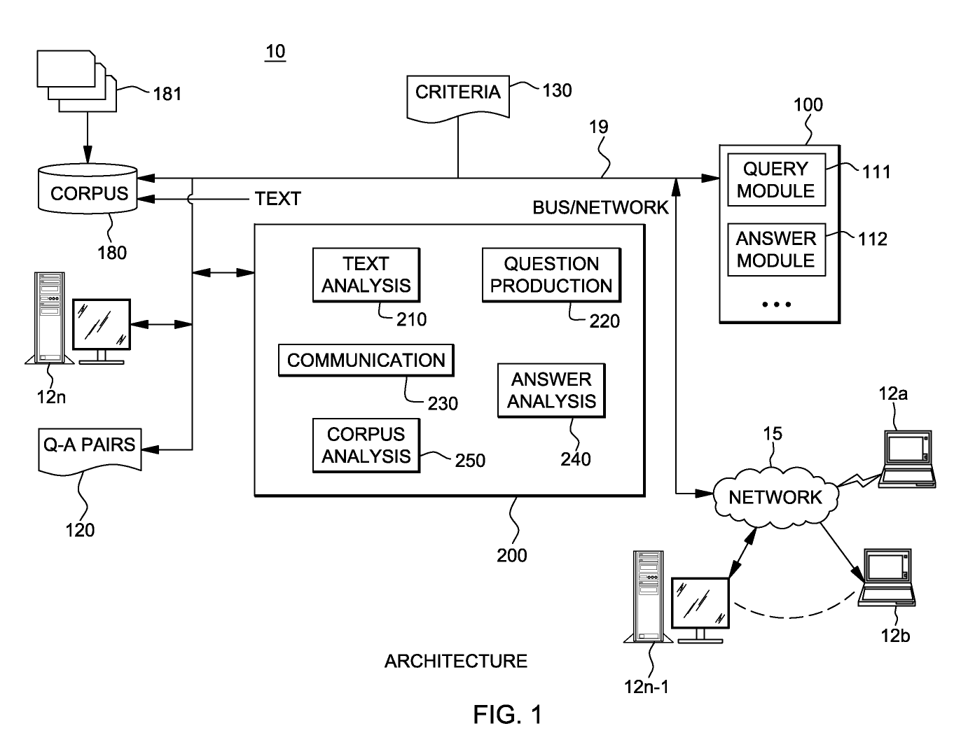

FIG. 1 shows a system diagram depicting a high-level logical architecture 10 and methodology for generating question-answer (QA) pairs based on a corpus of textual data. As shown in FIG. 1, the high level logical architecture includes a network 15 including a data bus or like communications link 19 forming an interconnection including the following elements: a QA system 100 for “open” domains and a QA control module 200.

More particularly, the system 10 is established for enabling question/answer (“QA”) generation based on any corpus of textual data represented as stored in a memory storage or database device 180. As shown in FIG. 1, the system architecture enables QA generation functionality for one or multiple users via respective computing devices 12a, . . . 12n, in one embodiment. In one aspect, devices 12a, . . . , 12n enable users of the system to access the system 10 via either directly or remotely via wired or wireless connections to the network 15 and/or bus 19 which interconnects the system components. In one embodiment, network 15 may include a local area network. LAN, wide area network WAN, a private Intranet or the Web/Internet 15. Wired communications between the system 10 and the devices 12a, . . . , 12n are via the public Internet in accordance with standard TCP/IP protocols and optionally, over a secure communications link, e.g., secure sockets layer, BlueTooth or similar like communications protocol. It is understood that devices 12a, . . . , 12n for accessing the system, and optionally, the Web/Internet, may comprise a personal computer/computing device, personal digital assistant, or like device implementing web-browser functionality, e.g., Firefox® or Internet Explorer®, or other compatible browsing technology.

More particularly, the system 10 for question-answer list generation obtains as its input a corpus of text 180 and a set of criteria 130 which the output list of question-answer pairs 120 needs to satisfy. The system 10 is connected to a question answering sub-system 100, which among other elements to be described in greater detail herein, includes a query module 111 receiving queries from module 200, and an answer generation module 112 for generating candidate answers. All the components are operating and communicate over a communication network (bus) 19.

The control module component 200 functions to accomplish the following, including but not limited to: analyzing text documents 181 provided or input to the corpus 180; suggesting questions about documents and passages; analyzing the quality of answers received from the QA sub-system 100; and, ensuring the collection of question-answer pairs 120 satisfies the criteria 130, e.g., criteria such as, but not limited to: coverage, number of questions, prominence of answers. In connection with making sure criteria are satisfied, the system ensures that no requirement can be part of criteria 130 without an implemented method or mechanism for compliance checking. For the task of—analysis of text documents—a Text-Analysis sub-module 210 performs text analysis (e.g., extracting predicate argument relations from text). It is understood that text analysis may be performed by a text analysis module of QA sub-system 100, obviating the need for module 210. That is, Text-Analysis sub-module 210 may include, for example, QA sub-system 100 component module 20 (Query Analysis) that would including, a Parse and Predicate Argument Structure processing block and a Lexical and Semantic Relations processing block. A collection of one or more of text analysis engines that provide at a minimum the Parse and Predicate Argument Structure is sufficient. Any existing natural language processing tools, such as e.g. http://en.wikipedia.org/wiki/Natural_Language_Toolkit, can be represented as UIMA TAEs (“text analysis engines”) within 210. For the last task of ensuring the collection of question-answer pairs 120 satisfies the criteria 130, a corpus analysis module 250 is provided that performs corpus analysis such as described, for example, in http://en.wikipedia.org/wiki/Corpus_linguistics and in particular http://en.wikipedia.org/wiki/Corpus_linguistics#Methods. The module 250 thus includes Annotation, Abstraction, Analysis (as in statistical analysis of the corpus). For example, for the purpose of annotation module 210 can be used and corpus analysis module 250 delegates this responsibility to module 210.

The control module component 200 further includes a question production module 220 for producing a list of candidate questions, and question answer (QA) pairs based on a text 181 and results of text analysis. Control module component 200 further includes an answer analysis 240 module capable of analyzing lists of question answer pairs and deciding whether a list of question answer pairs satisfies the criteria 130, e.g., coverage, number of questions, prominence of answers. For example, criteria 130 might require that all answers have entries in the Wikipedia. Thus, a check is performed to determine if an entity has a Wikipedia entry. A different requirement might call for any fact mentioned in the question to be well known. For example, Wikipedia maintains ‘popularity scores’ of articles, so the fact can be checked against articles satisfying some popularity threshold. Or, the fact is to be checked against other corpora, for example, popularity might be that it appears multiple times (say 3 or more in 4 or more sub-corpora) in the press, which for the purpose of a particular implementation might refer to on-line or stored versions of the New York Times, The WSJ, Time, and The Guardian. Yet another example might be that 70% of all “popular facts” about a topic X should be represented in a question-answer pair. This embodiment will thus implement mechanism for fact extraction, gathering statistics about the facts on X, and comparing their popularity, each step of which is algorithmically implementable: i.e., text analysis, computing popularity as described above, and computing coverage (e.g., by counting how many were in Q-A pairs, or by some statistical estimate: e.g., can extract correctly 80% of facts that are represented 5 times or more, and covered 90% of these).

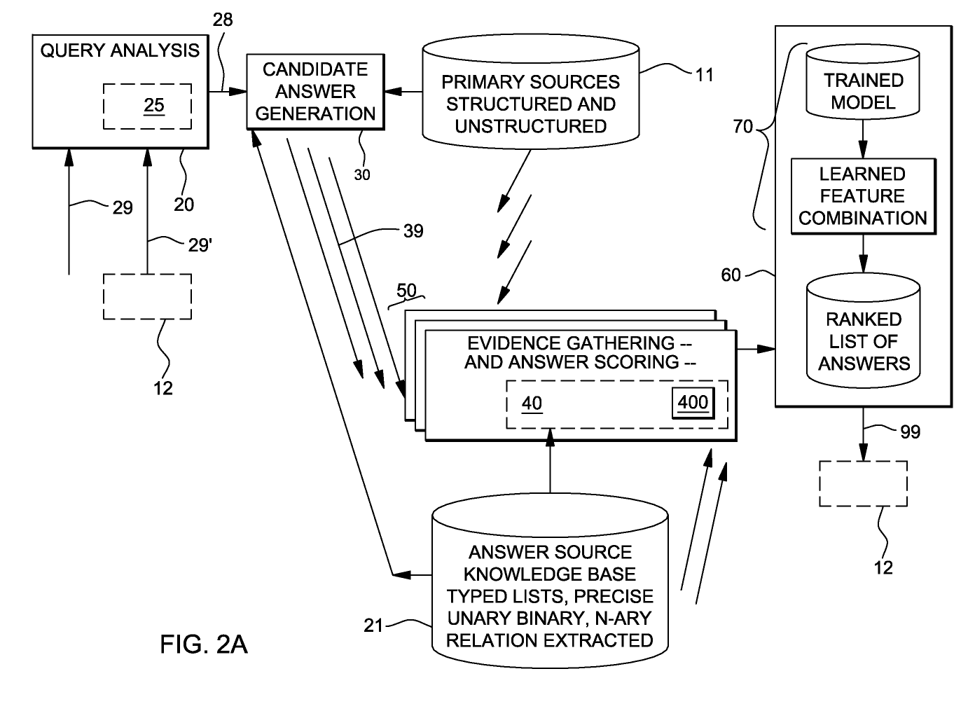

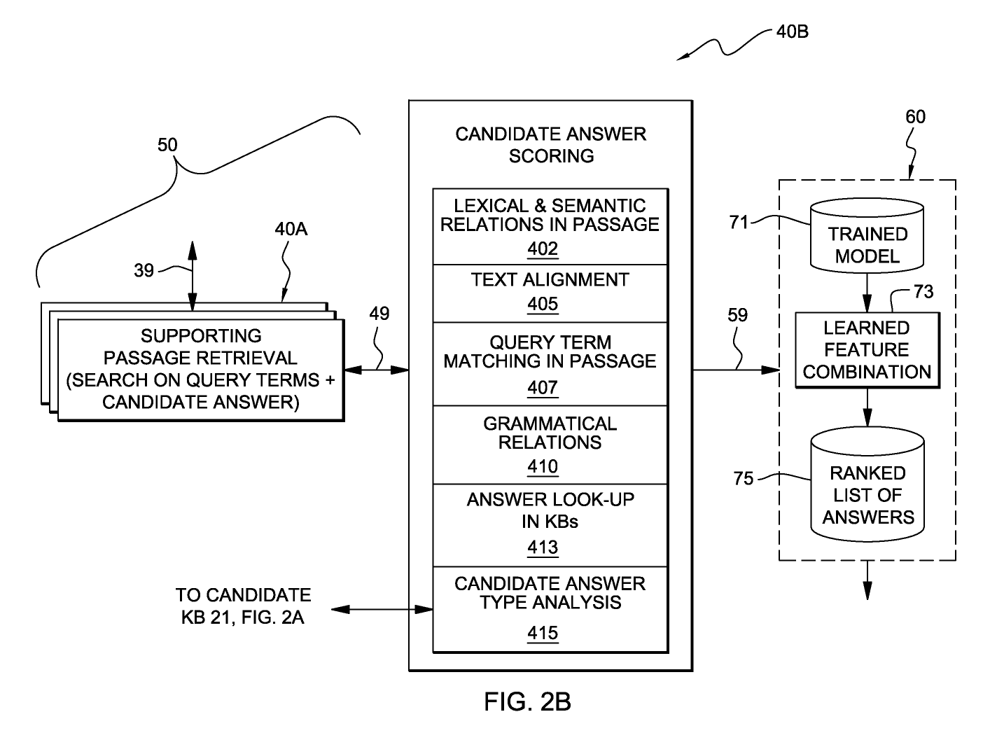

A communications module 230 is further provided that enables communication with the QA sub-system 100 over communications network or data bus 19 and users via devices 12a, . . . , 12n. Particularly, communications module 230 enables communication between other components of control module 200 (e.g., modules 210, 250 240) with the query module 111 of QA sub-system 100 and with answer modules 112 of QA sub-system 100. The query module 111 of FIG. 1 corresponds to and includes query analysis block 20 as shown in FIG. 2A, and answer modules 112 of QA sub-system 100 corresponds to and includes answer ranking block 60. Finally, via their respective devices 12a, . . . , 12n, functioning as Input/Output devices, users are presented with an interface 110, e.g., a display on a monitor screen, where a user can enter criteria, topic or domain of interest, interactively modify the set of criteria 130, receive answers to any ‘locally produced’ questions, or make and enter choices among questions and received answers.

In one embodiment, QA sub-system module 100 comprises and includes components as described in commonly-owned co-pending U.S. patent application Ser. Nos. 12/126,642 and 12/152,411, the whole contents and disclosure of each of which is incorporated by reference as if fully set forth herein.

FIG. 2A shows a detailed system diagram depicting a high-level logical architecture of QA sub-system module 100 of FIG. 1. As shown in FIG. 2A, the high level logical architecture includes the provision of a Query Analysis module 20 implementing functions for receiving and analyzing an initial user query or question.

In one aspect, a “user” refers to a person or persons interacting with the system, and the term “user query” refers to a query (and its context) 29 posed by the user. However, it is understood other embodiments can be constructed, where the term “user” refers to a computer device or system 12 generating a query by mechanical means, and where the term “user query” refers to such a mechanically generated query and context 29′. A candidate answer generation module 30 implements a search for candidate answers by traversing structured, semi structured and unstructured sources included in the corpus 180. The corpus 180 is shown indicated in FIG. 2A as a “Primary Sources” module 11. In a further embodiment, the corpus 180 shown in FIG. 2A may further comprise an Answer Source Knowledge Base module 21 that includes collections of relations and lists extracted from primary sources. All the sources of information can be locally stored or distributed over the network 15, including the Internet. The Candidate Answer generation module 30 generates a plurality of output data structures containing candidate answers based upon the analysis of retrieved data. In FIG. 2A, the system 100 further includes an Evidence Gathering module 50 interfacing with the primary sources 11 and knowledge base 21 for concurrently analyzing the evidence based on passages having candidate answers, and scoring each of candidate answers, in one embodiment, as parallel processing operations. In one embodiment, the architecture may be employed utilizing the Common Analysis System (CAS) candidate answer structures (such as is described at incubator.apache.org/uima/ . . . /uima/cas/package-summary.html), and implementing Supporting Passage Retrieval as will be described in greater detail herein below. This processing is depicted in FIG. 2A where the Evidence Gathering module 50 comprises a Candidate Answer Scoring module 40 for analyzing a retrieved passage and scoring each of candidate answers of a retrieved passage. More particularly, this processing is depicted in FIG. 213 where the Evidence Gathering module 50 comprises a Supporting Passage Retrieval 40A and a Candidate Answer Scoring 40B as processing modules for concurrently analyzing the passages and scoring each of candidate answers as parallel processing operations.

Further, in FIG. 2A, where the corpus includes the Answer Source Knowledge Base 21, additionally this Knowledge Base may comprise one or more databases of structured or semi-structured sources (pre-computed or otherwise) comprising collections of relations (e.g., Typed Lists). In an example implementation, the Answer Source knowledge base may comprise a database stored in a memory storage system, e.g., a hard drive. An Answer Ranking module 60 provides functionality for ranking candidate answers and determining a response 99 returned to a user via a user's computer device display interface or a computer system 12, where the response may be an answer, or an elaboration of a prior answer or, for example, a request for clarification in response to a question—when a high quality answer to the question is not found.

More particularly, in one embodiment, FIG. 2A shows a machine learning implementation where the “answer ranking” module 60 includes a trained model component 70 produced using a machine learning techniques from prior data. The prior data may encode information on features of candidate answers, the features of passages the candidate answers come, the scores given to them by Candidate Answer Scoring modules 40, and whether the candidate answer was correct or not. In other words, machine learning algorithms can be applied to the entire content of the CASes together with the information about correctness of the candidate answer. Such prior data is readily available for instance in technical services support functions, or in more general setting on Internet, where many websites list questions with correct answers.

It is understood that skilled artisans may implement a further extension to the system of the invention shown in FIG. 2A, to employ one or more modules for enabling I/O communication between a user or computer system 12 and the system 100 according to, but not limited to: the following modalities of text, audio, video, gesture, tactile input and output etc. Thus, in one embodiment, both an input query and a generated query response may be provided in accordance with one or more of multiple modalities including text, audio, image, video, tactile or gesture. Thus, for example, if a question is posed using other modalities, e.g. a series of images pointed by the user, the invention applies to the textual aspects of the images, captured in their descriptions or inferred by an analysis system (not shown).

This processing depicted in FIG. 2A, may be local, on a server, or server cluster, within an enterprise, or alternately, may be distributed with or integral with or otherwise operate in conjunction with a public or privately available search engine in order to enhance the question answer functionality in the manner as described. Thus, functionality for system 100 may be provided as a computer program products comprising instructions executable by a processing device, or as a service deploying the computer program product. The architecture employs a search engine (a document retrieval system) as a part of Candidate Answer Generation module 30 which may be dedicated to the Internet, a publicly available database, a web-site (e.g., IMDB.com) or, a privately available database. Databases can be stored in any storage system, e.g., a hard drive or flash memory, and can be distributed over the network or not.

As mentioned, the Common Analysis System (CAS), a subsystem of the Unstructured Information Management Architecture (UIMA) that handles data exchanges between the various UIMA components, such as analysis engines and unstructured information management applications, is implemented. CAS supports data modeling via a type system independent of programming language, provides data access through an indexing mechanism, and provides support for creating annotations on text data, such as described in (http://www.research.ibm.com/journal/sj/433/gotz.html) incorporated by reference as if set forth herein. It should be noted that the CAS allows for multiple definitions of the linkage between a document and its annotations, as is useful for the analysis of images, video, or other non-textual modalities (as taught in the herein incorporated reference U.S. Pat. No. 7,139,752).

In one embodiment, the UIMA may be provided as middleware for the effective management and interchange of unstructured information over a wide array of information sources. The architecture generally includes a search engine, data storage, analysis engines containing pipelined document annotators and various adapters. The UIMA system, method and computer program may be used to generate answers to input queries. The method includes inputting a document and operating at least one text analysis engine that comprises a plurality of coupled annotators for tokenizing document data and for identifying and annotating a particular type of semantic content. Thus it can be used to analyze a question and to extract entities as possible answers to a question from a collection of documents.

In one non-limiting embodiment, the Common Analysis System (CAS) data structure form is implemented as is described in commonly-owned, issued U.S. Pat. No. 7,139,752, the whole contents and disclosure of which is incorporated by reference as if fully set forth herein and described in greater detail herein below.

As further shown in greater detail in the architecture diagram of FIG. 2A, the “Query Analysis” module 20 receives an input that comprises the query 29 entered, for example, by a user via their web-based browser device 12. An input query 29 may comprise a string such as the topic or domain of an example to described herein below relating to “Event(s) in Ancient Greece”. In one example, an initial query may comprise a question Who was the tallest American president?” Alternately, a question may consist of a string and an implicit context, e.g., “Who was the shortest?” In this example, context may range from a simple another string e.g. “American presidents” or “Who was the tallest American president?” to any data structure, e.g. all intermediate results of processing of the previous strings—a situation arising e.g., in a multiple turn dialog. The input query is received by the Query Analysis module 20 which includes, but is not limited to, one or more the following sub-processes: A Parse and Predicate Argument Structure block (not shown) that implements functions and programming interfaces for decomposing an input query into its grammatical and semantic components, e.g., noun phrases, verb phrases and predicate/argument structure. An (English Slot Grammar) ESG-type parser may be used to implement parsing, in one embodiment; A Focus Segment, Focus & Modifiers block is provided that computes the focus and focus modifiers of the question. Further implementations may further include a Question decomposition block (not shown) in the query analysis module 20 that implements functions and programming interfaces for analyzing the input question to determine the sets of constraints specified by the question about the target answer. The query analysis block 20 may further includes a Lexical Answer Type (LAT) block 25 that implements functions and programming interfaces to provide additional constraints on the answer type (LAT). The computation in the block 20 comprises but is not limited to the Lexical Answer Type.

Thus, the QA sub-system module 100 leverages the concept of “Lexical Answer Type” (LAT) not the “ontological answer type”. While the two are related, ontologies are typically predefined (and finite), the LATs are computed from a natural language analysis of the query and provide more a description of an answer than its ontological category.

In FIG. 2A, the LAT block 25 includes certain functions/sub-functions (not shown) to determine the LAT. These sub-functions, in one embodiment, include a parser such as the ESG parser as described herein above, and, a co-reference resolution module (as described e.g. in http://www.isi.edu/˜hobbs/muc5-generic-final.pdfi and http://gate.ac.uk/sale/taln02/taln-ws-corefpdf).

The certain functions/sub-functions operate to compute a LAT from a natural language analysis of the query and provide more a description of an answer than its ontological category. Thus, for example, the italicized words in the following sentence represent the LAT “After circumnavigating the Earth, which explorer became mayor of Plymouth, England?” the answer must include both “explorer” and “mayor”; and these two strings become the question LATs.

As mentioned above, a LAT of the question/query is the type (i.e. the descriptor) of the referent of the entity that is a valid answer to the question. In practice, LAT is the descriptor of the answer detected by a natural language understanding module (not shown) comprising a collection of patterns or a parser with a semantic interpreter.

It is understood that additional functional blocks such as a Lexical and Semantic Relations module to detect lexical and semantic relations in the query; a Question Classification block that may employ topic classifiers providing information addressing, and, a Question Difficulty module executing methods providing a way to ascertain a question's difficulty is included in the query analysis module 20 as described in herein incorporated commonly-owned, co-pending U.S. patent application Ser. No. 12/152,411.

With reference to the Lexical Answer Type (LAT) block 25, in the query analysis module 20 of FIG. 2A, the LAT represents the question terms that identify the semantic type of the correct answer. As is known, a LAT may be detected in a questions through pattern rules such as “any noun phrase that follows the wh-word and serves as the subject or the object of the main verb in a question is a LAT”. For example, in question “Which Dublin-born actor once married Ellen Barkin?”, the noun phrase “Dublin-born actor” follows the wh-word “which”, and is the subject of the main verb, “marry”. LAT detection rules can be encoded manually or learned by machine automatically through association rule learning. In this case, the natural language understanding module can be limited to implementating the simple rules as described above.

LATs should include modifiers of the main noun if they change its meaning. For example, a phrase “body of water” has different meaning than “water” or “body”, and therefore in the following query the LAT has to include the whole phrase (italicized):

“Joliet and Co found that the Mississippi emptied into what body of water?”

It is understood that multiple LATs can be present in the query and the context, and can even be present in the same clause. For example, words italicized represent the LAT in the following queries:

“In 1581, a year after circumnavigating the Earth, which explorer became mayor of Plymouth, England?”
“Which New York City river is actually a tidal strait connecting upper New York Bay with Long Island Sound?”

Even though in many cases the LAT of the question can be computed using simple rules as described herein above, in other situations such as when multiple LATs are present, in the preferred embodiment, the LATs are computed based on grammatical and predicate argument structure. Thus the natural language understanding module should include a parser (such as ESG is used to compute the grammatical structures) and a shallow semantic interpreter to compute the semantic coreference between the discourse entities, such as “river” and “tidal strait” or “explorer” and “mayor” to add both of them to the list of LATs. It is understood that the LATs can include modifiers.

Thus, in the first example above, the list of LATs may be contain [explorer,mayor, mayor of Plymouth, mayor of Plymouth, England]. A minimal possible noun phrase that identifies the answer type corresponds to the maximal entity set, and the maximal noun phrase provides the best match.

In one example implementation, a LAT is used without modifiers for better coverage: e.g., it is easier to figure out someone is an author than a 20th-century French existentialist author. Matching a LAT including modifiers of the head noun produces a better match, but typically requires a large set of sources. From the above, it should be clear that a LAT is not an ontological type but a marker. Semantically, it is a unary predicate that the answer needs to satisfy. Since multiple LATs are the norm, and matches between candidate LATs and query LAT are usually partial, a scoring metric is often used, where the match on the LATs with modifiers is preferred to the match on simple head noun.

A method of “deferred type evaluation”, may be implemented in the QA sub-system module 100 in one embodiment. With respect to FIG. 2, a first processing step 100 represents the step of receiving an input query, and generating a data structure, e.g., a CAS structure, including a question string and context for input to the Lexical Answer Type (LAT) block 200 (FIG. 1) where, as indicated at step 115, the Query is analyzed and lexical answer type (LAT) is computed. As a further example provided herein only for non-limiting purposes of discussion, an input query, to wit:

“which 19th century US presidents were assassinated?”

would compute an lexical answer type (LAT) as “19th century US president” (but also as “US president” and “president”).

As a result of processing in the LAT block 25, there is generated an output data structure, e.g., a CAS structure, including the computed LAT and additional terms from the original query.

For example, alternately, or in addition, the functional modules of the query analysis block 20 may produce alternative ways of expressing terms. For example, an alternative way, or a pattern, of expressing “19th century”, e.g., will include looking for a string “18\d\d” (where \d stands for a digit, “XIXth ce.” etc. Thus, the query analysis block may investigate presence of synonyms in query analysis. Note the lists of synonyms for each date category is either finite or can be represented by a regular expression)

Further, it is understood that while “president” (which is a more general category) and “US president” form a natural ontology, the additional modifiers: “19th century” as in this example, or “beginning of the XXth century” are unlikely to be part of an existing ontology. Thus, the computed LAT serves as a “ontological marker” (descriptor) which can be but doesn't have to be mapped into an ontology.

As result of processing in the LAT block 25 then, there is generated an output data structure, e.g., a CAS structure, including the computed the original query (terms, weights) (as described in the co-pending U.S. patent application Ser. No. 12/152,411.

Referring back to FIG. 2A, an output 28 of the Question/Query analysis block 20 comprises a query analysis result data structure (CAS structure). In this embodiment, an output data structure Question/Query analysis module 20 and candidate answer generation module 30 may be implemented to pass the data among the modules, in accordance with the UIMA Open Source platform.

As further described with respect to FIG. 2A, the “Candidate Answer Generation” module 30 receives the CAS-type query results data structure 28 output from the Question/Query analysis block 20, and generates a collection of candidate answers based on documents stored in Primary Sources 11 and in Answer Source KB 21. The “Candidate Answer Generation” module 30 includes, but is not limited to, one or more of the following functional sub-processing modules: A Term Weighting & Query Expansion module implementing functions for creating a query against modules 11 and 21 (part of query generation) with an embodiment implementing query expansion (see, e.g., http://en.wikipedia.org/wiki/Query_expansion); a Document Titles (Document Retrieval in Title Sources) module implementing functions for detecting a candidate answer (from sources 11 and 21); an Entities From Passage Retrieval module implementing functions for detecting a candidate answer in textual passages, e.g. based on grammatical and semantic structures of the passages and the query; and, an KB Entities from Structured Sources module implementing functions for retrieving a candidate answer based on matches between the relations between the entities in the query and the entities in Answer Source KB 21, (implemented, e.g., as an SQL query).Further, referring to FIG. 2A, as a result of implementing the functional modules of the Candidate Answer Generation block 30, a query is created and run against all of the structured and unstructured primary data sources 11 in the (local or distributed) sources database or like memory storage device(s). This query is run against the structured (KB), semi-structured (e.g., Wikipedia, IMDB databases, a collection of SEC filings in XBRL, etc.), or unstructured data (text repositories) to generate a candidate answer list 39 (also as a CAS, or an extension of prior CAS). It should be understood that, in one embodiment, the query is run against the corpus, e.g., which may include a local copy of the listed primary source databases, or, may be access the publically available public database sources. Moreover, it should be understood that, in one embodiment, not all terms from the query need to be used for searching the answer—hence the need for creating the query based on results of the query analysis. E.g. “five letter previous capital of Poland”—the terms “five letter’ should not be part of the query.

While not shown in FIG. 2A, the Answer Source Knowledge Base 21 interfaces with an Entities from Structured Sources module that includes; Typed Lists (e.g., list of all countries in world), Precise Unary (e.g., a country), Binary (e.g., country+head of state of country), Ternary (e.g., country+head of state of country+wife of head of state), n-ary Relation Extracted, etc.

A further processing step involves searching for candidate answer documents, and returning the results. Thus, for the example query described above (”which 19th century US presidents were assassinated?”) the following document including candidate answer results may be returned, e.g.,
http://en.wikipedia.org/wiki/List_of_United_States_Presidential_assassination_attempts,
http://www.museumspot.com/know/assassination.htm,
http://www.presidentsusa.net/presvplist.html

As a result of processing in the candidate answer generation module 30, there is generated an output data structure 39, e.g., a CAS structure, including all of the documents found from the data corpus (e.g., primary sources and knowledge base).

Then there is performed analyzing each document for a candidate answer to produce a set of candidate answers which may be output as a CAS structure using LAT (the lexical answer type).

For the example questions discussed herein, as a result of processing in the candidate answer generation module 30, those candidate answers that are found will be returned as answer(s): e.g., Abraham Lincoln, James A. Garfield.

The final answer is computed in the steps described above, based on several documents. One of the documents, http://www.museumspot.com/know/assassination.htm, states that “Four presidents have been killed in office: Abraham Lincoln, James A. Garfield, William McKinley and John F. Kennedy”.

In particular, the following steps may be implemented: for each candidate answer received, matching the candidate against instances in the database which results in generating an output data structure, e.g., a CAS structure, including the matched instances; retrieving types associated with those instances in the knowledge base (KB); and, attempting to match LAT(s) with types, producing a score representing the degree of match.

Thus continuing the above example, the parser, semantic analyzer, and pattern matcher—mentioned above in the discussion of query analysis—are used (in the preferred embodiment) to identify the names of the presidents, and decide that only the first two qualify as “XIXth century”.

More particularly, the candidate and LAT(s) are represented as lexical strings. Production of the score, referred to herein as the “TyCor” (Type Coercion) score, is comprised of three steps: candidate to instance matching, instance to type association extraction, and LAT to type matching. The score reflects the degree to which the candidate may be “coerced” to the LAT, where higher scores indicate a better coercion.

In candidate to instance matching, the candidate is matched against an instance or instances within the knowledge resource, where the form the instance takes depends on the knowledge resource. With a structured knowledge base, instances may be entities, with an encyclopedic source such as Wikipedia instances may be entries in the encyclopedia, with lexical resources such as WordNet (lexical database) instances may be synset entries (sets of synonyms), and with unstructured document (or webpage) collections, instances may be any terms or phrases occurring within the text. If multiple instances are found, a rollup using an aggregation function is employed to combine the scores from all candidates. If no suitable instance is found, a score of 0 is returned.

Next, instance association information is extracted from the resource. This information associates each instance with a type or set of types. Depending on the resource, this may take different forms; in a knowledge base, this corresponds to particular relations of interest that relate instances to types, with an encyclopedic source, this could be lexical category information which assigns a lexical type to an entity, with lexical resources such as WordNet, this is a set of lexical relations, such as hyponymy, over synsets (e.g. “artist” is a “person”), and with unstructured document collections this could be co-occurrence or proximity to other terms and phrases representing type.

Then, each LAT is then attempted to match against each type. A lexical manifestation of the type is used. For example, with encyclopedias, this could be the string representing the category, with a lexical resource such as WordNet, this could be the set of strings contained within the synset. The matching is performed by using string matching or additional lexical resources such as Wordnet to check for synonymy or hyponymy between the LAT and type. Special logic may be implemented for types of interest; for example person matcher logic may be activated which requires not a strict match, synonym, or hyponym relation, but rather that both LAT and type are hyponyms of the term “person”. In this way, “he” and “painter”, for example, would be given a positive score even though they are not strictly synonyms or hyponyms. Finally, the set of pairs of scores scoring the degree of match may be resolved to a single final score via an aggregation function.

Thus, in an example implementation, for the example question, each candidate answer in the document is automatically checked against the LAT requirement of “US president” and “19th century” |“18\d\d”| “XIXth ce.” “(where the vertical bar stands for disjunction). This may be performed by the Candidate Answer Scoring block 40, shown in FIG. 2A, as part of the evidence gathering module 50, and particularly, a Candidate Answer Type Analysis module 400 that produces a probability measure that Candidate Answer is of the correct type based, e.g., on a grammatical and semantic analysis of the document with which the Candidate Answer appears. In one embodiment, this processing entails using an automated scoring function that compares candidate answer lexical types (LAT) to the query LAT and producing a score for each candidate answer. The a scoring function can be expressed as a weighted combination of different typing scores, and, in one embodiment it may be expressed as

TyCorScore=0.2.*TyCorWordNet+0.5*TyCorKB+0.4*TyCorDoc

This expresses the preferences for more organized sources such as knowledge bases (KB), followed by type matching in a retrieved document, and synonyms being least preferred way of matching types.

For the given examples with presidents, each candidate answer from the museumspot.com list would get a score of 0.4.*2 (matching US president); the correct candidate answers from Wikipedia would get 0.4.*3 (matching US president, and matching the pattern for 19^{th} century). The other scores would be zero (WordNet and TyCorKB).

Of course, other combinations of scores are possible, and the optimal scoring function can be learned as described in the co-pending U.S. patent application Ser. No. 12/152,411.

The scoring function itself is a mathematical expression, that—in one embodiment—could be based on the logistic regression function (a composition of linear expressions with the exponential function), and may be applied to a much larger number of typing scores.

The output of the “Candidate Answer Scoring” module 40 is a CAS structure having a list of answers with their scores given by the processing modules in the answer scoring modules included in the Candidate Answer Scoring block 40 of the evidence gathering module 50. In one embodiment, these candidate answers are provided with TyCor matching score as described herein above.

It is understood that he top candidate answers (based on their TyCor scores) are returned.

Further, in one embodiment, a machine learning Trained Model and the Learned Feature Combination (block 70, FIGS. 2A, 2B) is implemented to: 1. Identify best answer among candidates; and, 2. Determine a confidence in the answer. In accordance with this processing, 1. Each question-candidate pair comprises an Instance; and, 2. LAT Scores are obtained from a wide range of features, e.g., co-occurrence of answer and query terms; whether LAT candidate matches answer LAT type (TyCor scores),etc. As described in the co-pending U.S. patent application Ser. No. 12/152,411, the Trained Model can be used to derive the optimal TyCor scoring function for LATs based on prior data.

Referring back to FIG. 2B, the “Candidate Answer Scoring” module 40B receives a CAS-type data structure 49 (i.e., CAS or CASes) output from the Supporting Passage Retrieval (SPR) block 40A of Evidence Gathering block 50, for example. The “Candidate Answer Scoring” module 40B includes, but is not limited to, one or more the following functional sub-processing modules: a Lexical & Semantic Relations in Passage module 402 implementing functions computing how well semantic (predicate/argument) relations in the candidate answer passages are satisfied (part of answer scoring); a Text Alignment module 405 implementing functions for aligning the query (or portion thereof) and the answer passage and computing the score describing the degree of alignment, e.g., when aligning answers in a quotation; a Query Term Matching in Passage module 407 implementing functions for relating how well a passage in the query match to terms in the candidate answer passages (part of answer scoring); a Grammatical Relations block 410 implementing functions for detecting a grammatical relations among candidate answers which can be subsumed under Lexical & Semantic Relations in Passage module 402; an Answer Look-up in KBs module 413 implementing functions for detecting the candidate answer based on the score ranking; and, a Candidate Answer Type Analysis (produces a probability measure that Candidate Answer is of the correct type based, e.g., on a grammatical and semantic analysis of the document with which the Candidate Answer appears) module 415. The output of the “Candidate Answer Scoring” module 40B is a CAS structure having a list of answers with their scores given by the modules.

As described herein, multiple parallel operating modules may be implemented to compute the scores of the candidate answers with the scores provided in CAS-type data structures 59 based on the above criteria: e.g., is the answer satisfying similar lexical and semantic relations (e.g. for a query about an actress starring in a movie, is the answer a female, and does the candidate satisfy actor-in-movie relation?); how well does the answer and the query align; how well the terms match and do the terms exist in similar order. Thus, it is understood that multiple modules are used to process different candidate answers and thus, potentially provide many scores in accordance with the number of potential scoring modules.

Thus in the QA sub-system architecture diagram of FIG. 2B, the “answer ranking” module 60 thus receives a plurality of CAS-type data structures 59 output from the Evidence Gathering block 50 (which includes implementing SPR 40A and Candidate Answer Scoring 40B), and generates a score for each candidate answer. FIG. 2B shows a machine learning implementation where the “answer ranking” module 60 includes a trained model component 70 produced using a machine learning techniques from prior data. The prior data may encode information on features of candidate answers, the features of passages the candidate answers come, the scores given to them by Candidate Answer Scoring modules 40B, and whether the candidate answer was correct or not. In other words, machine learning algorithms can be applied to the entire content of the CASes together with the information about correctness of the candidate answer. Such prior data is readily available for instance in technical services support functions, or in more general setting on Internet, where many websites list questions with correct answers. The model encodes a prediction function which is its input to the “Learned Feature Combination” module 73.

Thus, in FIG. 2B, there is input to the answer ranking module 60 a list of candidate answers, as a CAS, in addition to a trained model that is stored in the trained model sub-module 71 and whose parameters depend on the type of the query. The answer ranking module 60 includes a learned feature combination sub-block 73 which implements functionality that generates a ranked list of answers 75. An output of the answer ranking module 60 includes an answer to the query (one or a list); and, optionally a clarification question (if the system is engaging in a dialog or if none of the produced answers has a high rank). The learned feature combination sub-block 73 applies the prediction function produced by Trained Model 71, for example it implements methods that weight the scores of candidate answers based on the trained model. An example implementation of the training block 71 and of Learned Feature Combination 73 may be found in the reference to Ittycheriah, A. et al, entitled “{IBM}'s Statistical Question Answering System—{TREC}—”Text {REtrieval} Conference” in 2001 at ttp://citeseer.ist.psu.edukache/papers/cs2/7/http:zSzzSztrec.nist.govzSzpubszSztrec10zSz.zSzpa perszSztrec2001.pdf/ittycheriah01ibms.pdf).

More particularly, the application of a machine learning Trained Model 71 and the Learned Feature Combination 73 is now described in more detail. In one embodiment, a two-part task is implemented to: 1. Identify best answer among candidates; and, 2. Determine a confidence. In accordance with this processing, 1. Each question-candidate pair comprises an Instance; and, 2. Scores are obtained from a wide range of features, e.g., co-occurrence of answer and query terms; whether candidate matches answer type; and, search engine rank. Thus, for an example question,

“What liquid remains after sugar crystals are removed from concentrated cane juice”
example scores such as shown in the Table 1 below are generated based on but not limited to: Type Analysis (TypeAgreement is the score for whether the lexical form of the candidate answer in the passage corresponds to the lexical type of the entity of interest in the question); Alignment (Textual Alignment scores the alignment between question and answer passage); Search engine Rank; etc.

TABLE 1

| Candidate | Type | Align | Rank | Score |
|---|---|---|---|---|
| Milk | 1 | 0.2 | 3 | 0.46 |
| Muscovado | 0 | 0.6 | 1 | 0.48 |
| Molasses | 1 | 0.5 | 2 | 0.8 |

Thus, in this embodiment, candidate answers are represented as instances according to their answer scores. As explained above, a classification model 71 is trained over instances (based on prior data) with each candidate being classified as true/false for the question (using logistic regression or linear regression function or other types of prediction functions as known in the art). This model is now applied, and candidate answers are ranked according to classification score with the classification score used as a measure of answer confidence, that is, possible candidate answers are compared and evaluated by applying the prediction function to the complete feature set or subset thereof. If the classification score is higher than a threshold, this answer is deemed as an acceptable answer. Using the numbers for Type, Align and Rank of Table 1, and the prediction function (Score) given by an example linear expression:

=0.5*Type+0.8*Align+(1−Rank)*0.1

values are obtained for Milk, Muscovado, and Molasses 0.46, 0.48 and 0.8 (respectively, and the higher value being better). These values are represented in the Score column of TABLE 1. This example of scoring function is given for illustration only, and in the actual application more complex scoring functions would be used. That is, the mathematical expression is based, for instance, on the logistic regression function (a composition of linear expressions with the exponential function), and is applied to a much larger number of features.

A method of operating QA set generation in open domains, in one embodiment, is now described. In a first step, assuming there is available or input to the system 10 an initial question/answer criteria 130, text or corpus 180, the set of criteria is utilized to analyze a corpus of text data using the corpus analysis module 250 (FIG. 1) and QA sub-system 100 (FIGS. 2A, 2B) to produce results of that analysis 251 in the form of (attribute, value) list (or similar analysis data structure). Then, using criteria and the result of the analysis (analysis data structure), the question production module 220 generates an initial set of questions. The QA sub-system 100 retrieves a set of documents based on the initial set of questions, and, a text analysis module 210 performs an analysis of this set of documents to generate predicate-argument sets. In one embodiment, this results in an (additional) set of annotation on this set of documents, referred to now as a “new” set of documents. Then, the predicate/argument sets are converted into a set of questions and answers, where the answer is one or more arguments of a predicate and the question is a transformation of the predicate and remaining arguments. Then, the question production module 220 and text analysis module 210 (FIG. 1) is utilized to prune and/or modify the list of QA that do not satisfy the criteria 130. For example, if one of the criteria says not more than 3 words” and the argument is 5 words, it can be eliminated (pruned). It is understood that text analysis module 210 can further replace words by their synonyms or other names resulting in a set of QA pairs. The pruned question-answer list QA pairs of the previous step are input to the QA sub-system module 100 for additional processing, and answers to questions from the QA pairs are retrieved together with their generated scores and other parameters, supporting documents, etc. which constitute a new result set. This new result set is represented, e.g., as attribute-value lists, and include information about candidate answers to each questions with their scores, pointers to documents the candidates are in, relevant passages, etc., as well as results of analysis of the questions, answers, and documents by subsystems of 100. The new results set is then processed by control module 200 using criteria 130. This includes determining uniqueness of answers, confidence about thresholds, etc.. The parameters supplied in the new results set are based on the needs of the criteria 130. Ultimately, as a result of this processing there is determined which question-answer pairs satisfy the criteria. Thus, if a list question answers from the prior step satisfies the criteria they become the output of the process. Otherwise the process steps are repeated.

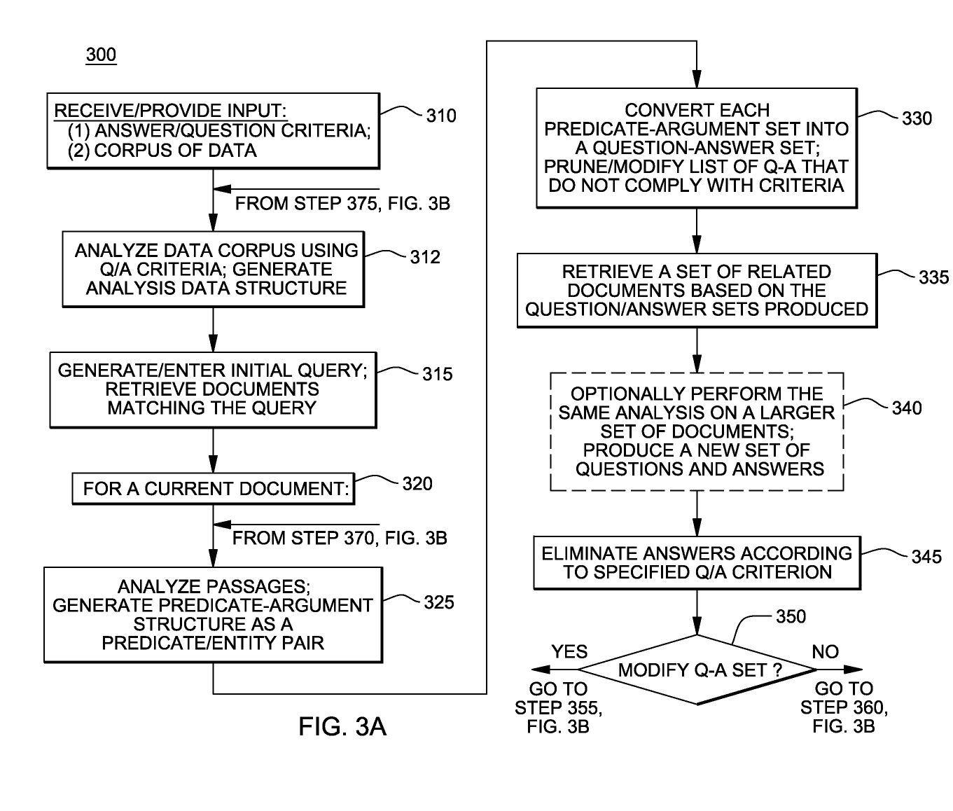

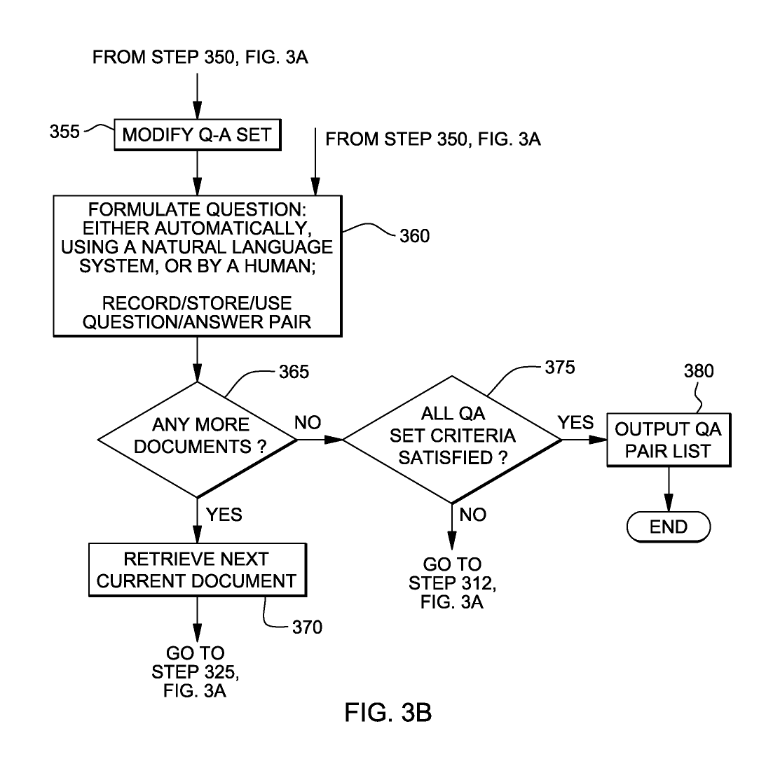

An example implementation of the methodology for extracting questions-answer pairs according to operation of the system 10 shown in FIG. 1 is now described in greater detail with respect to FIGS. 3A, 3B. In FIGS. 3A and 3B, the methodology 300 for extracting questions-answer pairs is now described according to an example. At a first step 310, there is input to the system the criteria for providing the questions and answer pairs. For example, the answer/question criteria may specify: a) that the question must uniquely identify the answer; b) that the answer must be one or two words at most (not counting stopwords like ‘a’, ‘the’ ‘of’ . . . ), for example; c) the question must include reference to a known event and/or a human. For example purposes of explanation, the methodology 300 is described in relation to an example topic or “open” domain of interest “Events in Ancient Greece”; and/or d) the list must cover all such important events described in the corpus. In one embodiment, these criteria are encoded at 310 as an attribute-value data structure. As further shown in FIG. 3A, at 310, there is further input to the system or provided the corpus of data 180 that includes documents that cover (among other things) the domain or topic, e.g., history of ancient Greece, in the example described herein. Thus, given the answer/question criteria and data corpus 180, the process proceeds from step 310 to step 312 where an analysis of the data corpus using Q/A criteria is performed to generate an analysis data structure (attribute, value) pairs. Then, the process proceeds to step 315 where the controller module 200 is prompted to initiate use of intelligent QA search system 100 to generate a query and retrieve documents matching the query.

Thus, in the example described herein, the QA sub-system 100 will search the corpus and retrieve documents related to “Event(s) in Ancient Greece”. As the documents are analyzed by control module 200, an example document might include a sentence that reads as follows:

“In 480 BC a small force of Spartans, Thespians, and Thebans led by King Leonidas, made a legendary last stand at the Battle of Thermopylae against the massive Persian army, inflicting a very high casualty rate on the Persian forces before finally being encircled.”

Particularly, prior to retrieving the documents, the Corpus Analysis module 250 analyzes the data 180 to detect, among other things, “events”, “countries”, “time”. This allows intelligent search of QA sub-system 100 to operate on the analyzed version of corpus 180.

Then, a processing loop 320, FIG. 3A, is entered whereby for each document retrieved as a result of the search of the analyzed corpus 180, at 325, the controller 200, upon prompting from a user or automatically via the system module, queries the natural language understanding module 210 to analyze the passage (of the document) and generate respective predicate/entity pairs. It is understood that a natural language understanding device 210 or system that only requires syntactic and/or semantic parsing as described, e.g., in http://en.wikipedia.org/wiki/Semantic_analysis_(computer_science)#Front_end; http://en.wikipedia.org/wiki/Parsing#Human_languages] may be used. It is understood that the same process is repeated for other documents received from the search process.

In the search process described use is made of parsing techniques that produces both: collection of (attribute, value) lists and predicate argument lists, the latter often represented as an (attribute, value) list, e.g. ((predicate, “kill”), (argument1, “Spartans”), (argument2, “Persians), (verb, ((head, kill),(tense, past),(number, 3) . . . )). In this particular example representation of “The Spartans killed the Persians”, a nested attribute-value list is used to represent predicate-argument structure and other information about the sentence. Attribute-value relations are extensively used in text processing.

Continuing to 330, FIG. 3, the result predicate-argument set is converted into a question-answer set. For example, given a pattern “Subject Verb Object” in a sentence it is changed into “Who/What Verb Object”. For example, parsing the phrase “John broke the window” would result in the following: John/Subject break[past]/Verb window[det [the]]/Object. Then the transformation to the question becomes: to “Who break[past] window[det [the]]” and then to “Who broke the window”. The [ ] brackets identify that typically some markers/annotations are placed on words and phrases and also represented as attribute-value lists. For the question about the object there is introduced the auxiliary “did” or “have”. What did John break” but otherwise the process is identical. For longer sentences, the process is the same, except that there are more modifiers, e.g. the phrase “at 5 pm last night, with a stick, when fixing the tree bent by last snow storm”. These modifiers are optional when asking the question, and remain attached where they were before (i.e. to their respective syntactic or semantic heads). Further, at 330, the list of QA that do not comply with criteria are pruned/modified.

The resulting initial questions/answer pairs 120 is based on the passages found in the respective documents for the topic or “open” domain of interest (e.g., “Events in Ancient Greece” topic described herein) and may include, for example:
1) “which force inflicted a very high casualty rate on the Persian forces before finally being encircled” (“force of Spartans, Thespians, and Thebans led by King Leonidas”
2) “which battle was a legendary last stand”! “Battle of Thermopylae”
3) “which force was led by King Leonidas”/“force of Spartans, Thespians, and Thebans”

Using the QA search system 100, at next step 335, FIG. 3A, a set of related documents is retrieved from the corpus based on the question/answer sets 120 produced at step 330. That is, the system retrieves documents which include an answer to the questions, i.e., a questions-answer set together with their scores and possibly other parameters, e.g., attribute value lists describing their semantic properties or metadata about documents they appear in. For example, for the topic or domain “Events in Ancient Greece” provided by way of example, a QA set may comprise results such as 1) ,2), 3) above together with their scores (and other data). It is understood that at 335, FIG. 3A, many more documents may be retrieved as a result of implementing this step. For example, in the QA set may comprise results such as 1), 2), 3) above. Nothing, in the example 1), 2) 3) questions above ask completely specifies the events of interest in ancient Greece. For example, there may be 20^{th} century battles involving Persians (Iranians); there may be many last stands (historic and metaphorical); and many kings with the same name leading a force (e.g., there are many kings named “Henry” if the example topic or domain was Historical England).

Thus, continuing to step 340, the method continues to perform the same analysis on a larger set of documents (as in step 325). Thus, for example, in addition to the questions and answers produced at step 330, there may be additionally generated:
Documents about Persians losing politically in WWII, and documents about Alexander the Great
Documents about Custer's legendary last stand in the Battle of Little Bighorn
Documents about a movie “300” (about King Leonidas), King Leonidas memorabilia and games etc.
Other new documents based the documents retrieved from processing at steps 340 and 350 (in this example, a path of one particular document is followed, but, in one aspect, steps 340 and 350 can produce thousands of them).

Thus, at step 340, as in steps 325, 330 an analysis is performed upon the large set of document producing predicate-entity pairs and, ultimately, a new set of questions and answers. These may yield new question/answer pairs e.g. about Alexander the Great and where and when he died, what countries he conquered etc. The performing of steps 335, 340 ensures that a greater amount of the important events covering the corpus is detected (as compared to steps 325, 330).

In the event that a list of questions and answers (QA result set) does not change anymore after iterating and checking an amount, e.g., half, of documents (for example, because of redundancy, many important events in ancient Greece will be appear many times), the system will continue to analyze all documents. Additionally, the process may return to already processed documents to obtain additional constraints on the predicates (for example, last document introduces a new important event, but the constraint to make it unique must come from a prior received document). For example, a prior document can mention the first construction of a vending machine in a temple in the 1^{st} century, BC in Greece; a current document can say that the ancient Greeks invented a vending machine. The answer to the question “who invented the vending machine” is not unique, but the constraints about time, place and use from the prior document will make it unique.

Continuing to step 345, a determination is made as to whether any questions can be eliminated as not complying with the criteria 130 established for the QA answer pairs. In one aspect, the analyzer 240 uses the criteria specified in step 110 to automatically determine compliance of the QA. For the example topic or domain “Events in Ancient Greece” provided by way of example, at step 350, the analyzer 240 may eliminate the first (1) and last question (3) of the example result QA set based on the criterion (b) that the answer should be succinct (e.g., no more than two words, or a proper name).

Continuing to step 350, FIG. 3A, the control module 200 determines if the QA set can be modified, e.g., whether additional predicates be added, and, performs the modification, e.g., asks for additional predicates. For example, in an effort to satisfy criterion c), an existing QA pair may be modified, in the example domain described herein for illustrative purposes:
a. “In 480 BC a small force led by King Leonidas took part in a legendary battle against the massive Persian army”.

That is given the candidate question about a “legendary battle” additional predicates corresponding to “in. 480 BC” “small army led by King Leonidas” are added to the QA pair, i.e., added to question (the answer remains the same), to make the event unique and further identified by typically used references. The predicate data that enables the modification of the predicate argument set is generated by the query Answer sub-system module 100. Thus, if predicates can be added, the process proceeds to step 355, FIG. 3B, where the predicates are added to the QA pair and then the process continues to step 360. Otherwise, if at step 350, FIG. 3A no additional predicates are to be added, the process proceeds to step 360, FIG. 3B.

It is understood that the additional predicates can be added based on other documents. That is, after obtaining a question about X from a document, e.g., “doc1”, it is found that it may produce too many candidates; thus, a second document, e.g., “doc2” is obtained about the entity X, with another predicate, which can now be added, thus, rendering a more unique answer. It is ensured that, e.g., the new predicates are not obscure. For example, based on an example question “who was awarded the Nobel Prize?” multiple candidate answers may be initially retrieved, e.g., including people who should have received Nobel over many years. Hence, there is a need to eliminate the candidate answer based on additional predicates and accurate scoring; e.g., all starting with the sentence Einstein was awarded the Nobel Prize, based on the question “who was awarded the Nobel Prize?” For example, adding additional predicates such as “in Physics”, “in 1921” make the answer unique, the scorers ensure the system has confidence in this answer.

At step 360, FIG. 3B, the final question is formulated either automatically by 200, possibly using the natural language system of 100, or by a human, e.g., through the user display interface 110. For the example topic/domain provided herein for illustrative purposes, a final QA pair may read as follows:
a. “what was the legendary battle against a massive Persian army in 480 BC in which King Leonidas led a small army?” with the answer being “The Battle of Thermopylae”.

In one embodiment, the system 10 maintains a running list of questions and answers 120 (FIG. 1). Thus, a final list 120 can be generated (i.e., for which all criteria 130 hold) for immediate or subsequent delivery as an output, and/or saved for future use.

Continuing to step 365, FIG. 3B, a determination is made as to whether all documents matching the entered query and retrieved at step 315 have been analyzed in the manner described in FIGS. 3A, 3B. If not, the process retrieves the next current document at 370 and returns to step 320 for QA pair processing. If the last document has been retrieved and processed, then the process proceeds to step 375 to ensure that all criteria of the formed QA pair has been satisfied.

If the criteria of the formed QA pairs in the generated output list have not been satisfied, then the process returns to step 312 to initiate the process again. Otherwise, the process proceeds to 380 where the generated QA pairs result list is output.

Thus, as depicted in FIGS. 3A, 3B, the process steps are repeated for all retrieved documents. That is, answer/question criterion (d) described herein setting forth that the generated output comprising a list 120 of QA pairs must cover all important events described in the corpus, can be satisfied by making sure that all documents have been analyzed, that all events have been extracted, and, for example, that all events that have Wikipedia entries (an example of checking importance) have a question and answer associated with them. The process of checking importance includes reference to data sources available to the QA sub-system 100, i.e., the corpus 180, and can include accessing internet and other data via network 15, e.g., to understand number of references to the answers. For example, if there's a requirement that the answer or a fact are known, Google or Yahoo search can be used to determine the search rank of the documents about the event. In the context of the topic domain discussed herein for exemplary purposes, a similar process would be applied to questions about “Alexander the Great” biographical events.

In a further aspect, a variant of this method is to generate a list of progressively easier questions about a person or event. This can cover a situation (as in College Bowl competition) where partial credits, partial answers and hints are part of the Q/A pair, and they can facilitate training or tutoring, for example. Such progressive lists can be used for training (e.g. to train analysts) and for entertainment. For example, adding additional facts that can be progressively revealed. For example, in the example question about Thermopylae the additional fact (not needed to uniquely determine the answer but helpful in coming with one) can say: “The name of this place stands for “hot gates” in Greek.

A further variant of the method arises when an initial list of questionlanswer pairs is created by a human, and the objective of the training session, game or test is to arrive at the best similar answer and justify it. Such situation can arise if the objective is to teach answering difficult questions such as: ‘which medium size health care companies are likely to merge in the next few months?’, ‘which of the NY municipalities are likely to default on their bonds in the next 10 years?’; or when exploring scenarios: ‘which African countries are likely to become failed states in the next four years and under what assumptions?’ In this embodiment, a subset of the corpus 180 may also be identified as including documents relevant to the initial set of question answer pairs.

Thus, in one embodiment, these example cases may constitute competitive training scenarios in which human-computer teams try to arrive at best answers by using their respective strengths: machines evaluating evidence and finding answers to questions requiring sifting through large amounts of statistics, and humans providing hints/guidance and making informed judgments. For example, in the NY municipalities default example, the machine might get bond ratings, comments from the web, documents from filings and other sources. A user may suggest looking for data on social networks of mayors and financial professionals and politicians, and formulate additional questions such as “are towns/companies/institutions with well connected mayors more likely to default or less?

Thus, in one embodiment, the system 10 solves the problem of automatic creation of a representative collection of question-answer pairs based on a corpus of text. One example application of the system/method is for tutoring, computer gaming etc. That is, the system generates automatically formulated sets of questions and answers based on a corpus of text. Several sub-problems are also solved to arrive at a viable solution: In formulating a question/answer pair, ensuring the question has a unique well defined answer; satisfying additional constraints on question and answers; an option to work in collaborative teams; and, using it in a question answering game and/or as a teaching/training/testing device.

### Educational Games

In accordance with one application, the system may be configured for playing question answering games and other new types of computer games. While QA games in open domains include predefined question/answer lists, the embodiment described herein does not require predefined questions; and allows open sets of answers.

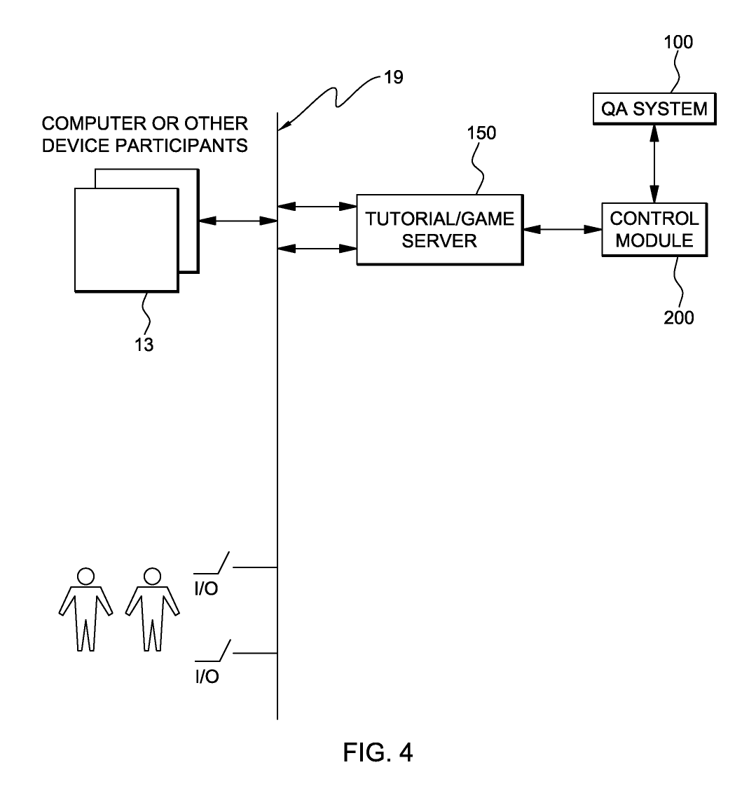

FIG. 4 illustrates a variant of the architecture described in FIG. 1 adapted for tutoring and/or gaming and which includes an interface between the QA sub-system 100 and a game server game server, tutoring server, etc., indicated as element 150. Such a server device 150 stores additional sets of criteria 130 (e.g., for grading or game playing, strategies), repositories of prior interactions, tutorials or games, interfaces for intervention of teachers, mentors and judges. Human-computer interface includes a browser device via a personal computer 12, or other interface devices including, but not limited to: a cell phone, or a game system like X-box or Wii shown in FIG. 4 as devices 13. It is understood that interfaces can be multimodal, and this includes either direction, thus the computer can for instance communicate by gestures or image or voice synthesis, etc.. Further, additional devices can be employed such as confidence meters showing system confidence in the answers to questions (and they can be shown to or hidden from participants, but available to observers in a competition; or, available to a “team” in cooperation. Further, as shown in FIG. 4, in addition to the QA-System 100 and the control module 200 described in FIG. 1, the architecture comprises a server 150 and zero or more computer participants 13. Human participants communicate with the server through an interface which can be a standard computer, but can include confidence meter showing the system's confidence in the answer, or a confidence sensor showing participants' confidence in the answer. The server 150 is configured to store strategy algorithms, collections of prior tutorial and games, alternative question-answer lists, etc. The bus 19 further includes multiple interfaces which can be further partitioned corresponding to the human or computer teams of participants. The server 300 then implements methods for team tutoring or playing (e.g. for keeping individual and team scores).

Further, as mentioned, the system is configured to (optionally) involve simulated human players, and multiple players/agents/computers [simultaneous or asynchronous]. Further, there may be multiple ways of playing (one turn vs. dialog) with the system adapted to accommodate multiple roles (e.g. computer asking vs. answering questions or likewise, a human asking vs. answering. Further, the system is adapted to enable competition or collaboration, whether it be for a single person or teams of users. For example, there may be a collaboration as a dual of competition with the provision of confidence meter feedback. Further, the system is adapted to enable multiple strategies for competing on speed of response (e.g., “buzzing”). For example, one strategy may be: 1. Based on confidence relative to players and their historical performance (e.g., the current game and previous games); 2. Based on game stage, rewards; 3. Based on assessment of self and other players with respect to topic or category (e.g., if my collaborator is good in topic 1 buzz less often) and, 4. Correlation and anti-correlation of performance.

Thus, in a method for tutoring and gaming, the above described method for QA list generation may include additional steps including, but not limited to: automatically preparing a list of question/answer pairs for one or more open domains; posing a question to one or more participants (user or device); evaluating the one or more answers; enforcing any “rules” of the game; providing references and justifications for answers; and, measuring the confidence in an answer.

Thus, in an example embodiment, for creating and running a question answering (QA) game, the process implemented for automatically preparing a list of question/answer pairs, each consisting of a question and an answer, involves: automatically choosing a list of entities (word, phrases) based on a criterion (e.g., not a common word and must have appeared in descriptions of some recent high profile event), and selecting one of the entities. Automatically creating a question by selecting a predicate (a longer phrase) in which the entity appears, and successively adding additional predicates (phrases) to ensure that the entity is uniquely determined by the predicate and the additional list of predicates. This is accomplished using the open domain question answering system, e.g., QA sub-system 100. In response, the system sets the question to the predicate and the additional list of predicates retrieved from the prior step, and sets the answer to the entity. The steps of creating questions and answers by selecting a predicate and adding additional predicates, and formulating the answer are repeated for each of the list of entities from the first step. As a further step, the resulting list of question/answer pairs may be ordered based on an additional criteria (e.g. succinctness, readability score, etc.)

In a further example embodiment, where the system is implemented for creating and running a question answering (QA) game, the process implemented for automatically preparing a list of question/answer pairs, each consisting of a question and an answer, involves: Automatically selecting a type of question (e.g. an event in ancient Greece); Automatically retrieving a list of such events (e.g., using the open domain question answering system). Automatically formulating questions and answers for each such event. Adding additional predicates (phrases) to the question to make the description select unique event as well as satisfy additional criteria (e.g., date or approximate date must be provided and a human participant must be named); and, Ordering the resulting list of question/answer pairs based on an additional criteria (e.g. succinctness, readability score, etc.)

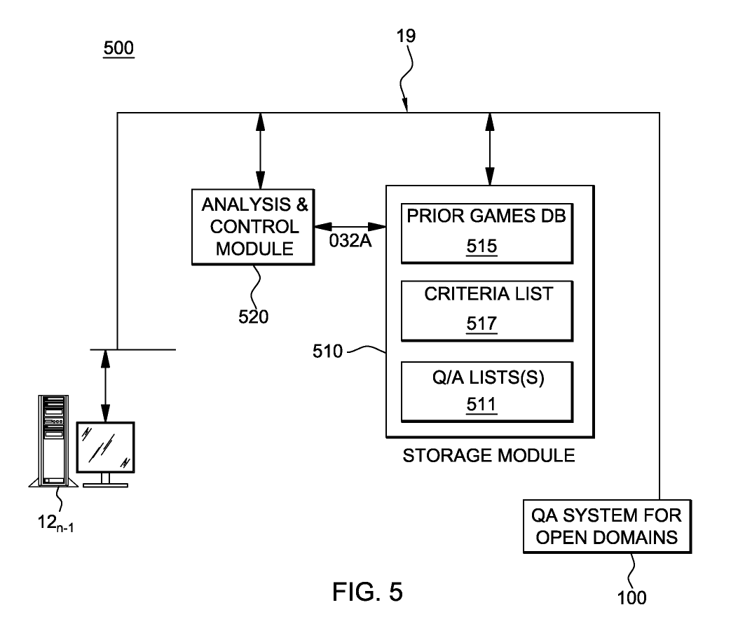

FIG. 5 illustrates a QA Game Preparation system 500 according to one aspect of the invention. For example, besides the QA sub-system module for Open Domains 100, there is provided an Analysis and Control Module 520 and data storage module 510. The analysis and control module 520 enables the enforcement of criteria/constraints 517 on the question/answer list 511 and may utilize the functionality for Question/answer extraction such as provided in QA sub-system module for Open Domains 100. A data storage device 510 is provided to store data including but not limited to: a “Prior” Games DB 515, the Criteria List 517, and generated Q/A List(s) 511. A computing device 12 or other device that can provide an user interface to the system is additionally included. Via the interface, a user can check and edit questions/answers 511, and/or provide criteria/constraints 517. Communications among the system components and the user interface device 12 is provided by the communications network connection 19.

A method for implementing the Game Preparation System 500 of FIG. 5 is now described. Assuming availability or input of Question/Answer Criteria, the system generates a Question/Answer List output, First, the method involves populating Criteria Lists 517 with requirements/constraints on Question/Answer pairs, e.g., via a human interface of device 12 or via a network connection 19 (e.g. from another computer). Then, the Analysis and Control Module 320 is invoked to communicate with the Open Domain QA sub-system 100 and request a list of candidate Question/Answer pairs based on criteria 517. This is accomplished via Open Domain QA sub-system 100 by searching for passages in acceptable domains and extracting candidate Q/A pairs using text analytics (natural language parsing). It is understood that other modules such as a prior games module 515 may suggest additional steps or methods, e.g., comparing with prior games with respect to a level of difficulty or topics (repeat or avoid repetition). Further, the module 320 analyzes candidate Q/A pairs based on the criteria list 517 and (optionally) the prior games DB 515 and produces Q/A list 511 to be stored in storage module 510.

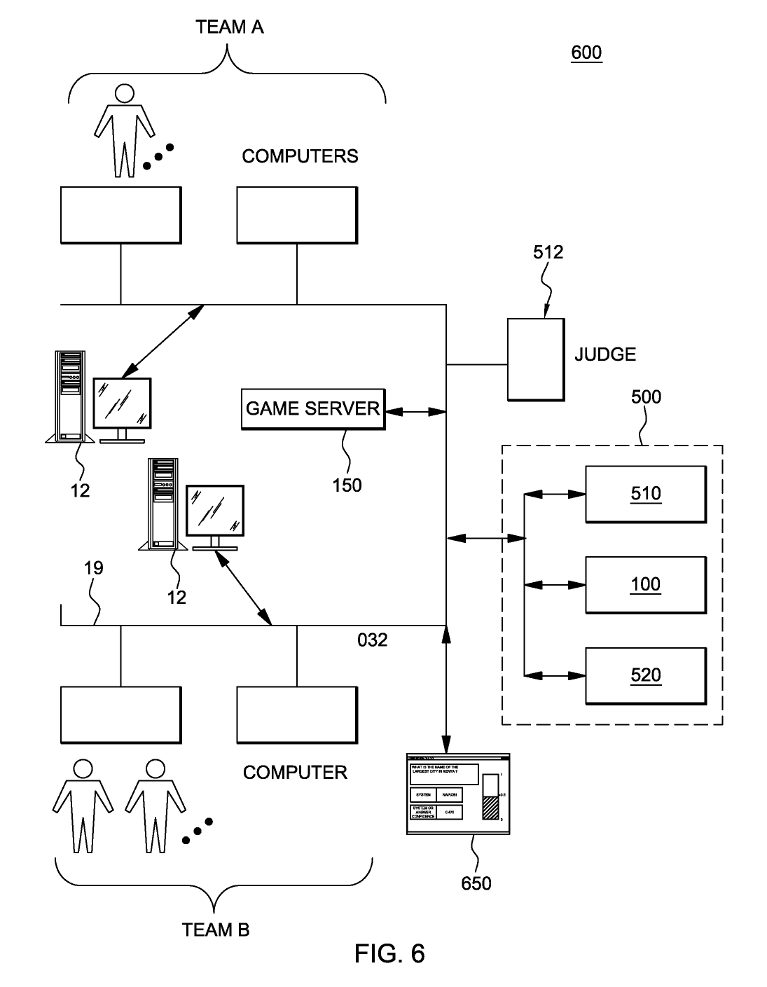

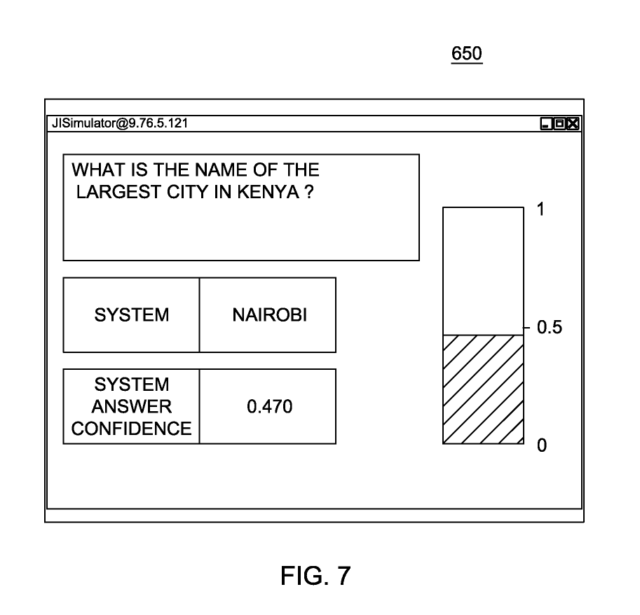

FIG. 6 shows a collaborative or competitive interactive gaming system 600 partitionable to accommodate teams of users that can interact with the Open Domain Gaming System 500 of FIG. 5. For example, system 600 includes the tutoring and/or gaming server device 150 of FIG. 4, and, the Open Domain Gaming System 500 of FIG. 5 including Analysis and Control Module 520, Open Domain QA sub-system 100 and storage module 510. The communications bus or like network data bus 19 further includes multiple interfaces (via computer devices) which can be further partitioned corresponding to the human or computer teams of participants and a judge, e.g., interacting via device 512. The server 150 then implements methods for team tutoring or playing, e.g. for keeping individual and team scores, such as, for example, competing Teams A and B shown in FIG. 6. Thus, the system 600 in FIG. 6 shows participants including users and computing devices 12 forming a team. It is understood that intelligent devices can be interfaced with the system 600 without users. The system further implements a confidence meter such as meter 700 shown in FIG. 7 which, in one embodiment, may be hidden from participants, but available to observers in competition; or, available to the team in cooperation/The system 600 is used for training (e.g. to train analysts). In one embodiment, confidence meter is software that summarizes the parameters of the candidate answers (using e.g. a linear combination of feature values) into one number (or a range of numbers (e.g., 66-72)) This number can be displayed e.g. as a bar. confidence meter 700 can be further used to show the confidence of the system in an answer, and provide additional information/entertainment besides the answer.

### Financial and Security Analaysis

In accordance with one application, the system may be configured for analyzing all data about a company, or a topic, e.g., “water pumps” (based e.g. on a focused crawl of the web). In this embodiment, the initial text corpus is augmented with additional textual data to ensure that criteria are satisfied (e.g., if the answer is a person, and has to be a well-known person, the system can add data by finding additional info on the web, e.g. number of Google hits and their context). I/O device or interface is to be used to interactively modify the criteria, select QA pairs, and make other decisions. Thus, the system can naturally improve over the state of the art of existing capabilities of so called exploratory search (see, for example, http://en.wikipedia.org/wiki/Exploratory_search).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

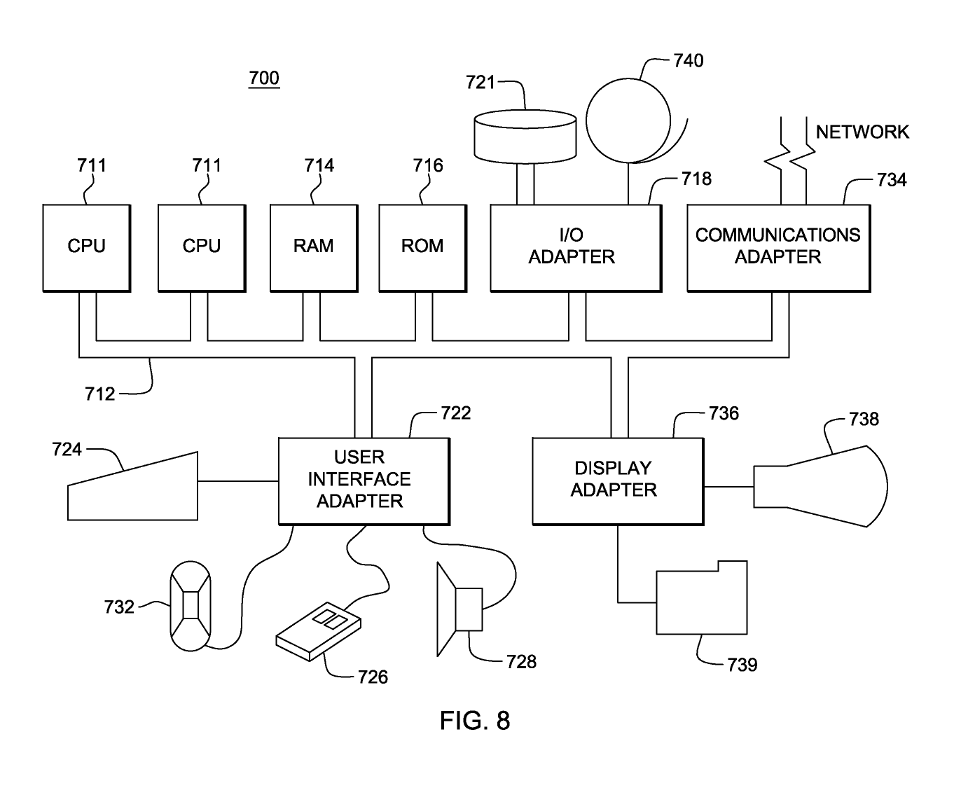

Referring now to FIG. 8, there is illustrated an exemplary hardware configuration of a computing system 700 running and/or implementing the method steps in FIGS. 3A and 3B. The hardware configuration preferably has at least one processor or central processing unit (CPU) 711. The CPUs 711 are interconnected via a system bus 712 to a random access memory (RAM) 714, read-only memory (ROM) 716, input/output (I/O) adapter 718 (for connecting peripheral devices such as disk units 721 and tape drives 740 to the bus 712), user interface adapter 722 (for connecting a keyboard 724, mouse 726, speaker 728, microphone 732, and/or other user interface device to the bus 712), a communication adapter 734 for connecting the system 700 to a data processing network, the Internet, an Intranet, a local area network (LAN), etc., and a display adapter 736 for connecting the bus 712 to a display device 738 and/or printer 739 (e.g., a digital printer of the like).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for generating questions and answers pairs based on any corpus of data, said method comprising:
generating, from a corpus of text data and a set of criteria, one ore more data structures;
generating, based on said set of criteria and one or more data structures, an initial set of questions;
retrieving a set of documents based on said initial set of questions;
generating from said documents, candidate question and answers;
conforming said set of candidate questions and answers to satisfy said set of criteria;
analyzing a quality of answers of said conformed set of questions and answers;
generating further one or more answers based on said analyzing; and,
outputting, based on said further one or more answers and said criteria, a final list question-answer (QA) pairs, wherein a program using a processor unit executes one or more of said generating, retrieving, generating, conforming, analyzing, generating and outputting.

2. The computer-implemented method of claim 1, wherein said generating candidate question and answers from said documents comprises:
generating, from said set of documents, predicate-argument sets; and
converting said predicate/argument sets of into a set of candidate questions and answers, an answer being one or more arguments of a predicate and the question being a transformation of the predicate and remaining arguments.

3. The computer-implemented method of claim 1, where said criteria includes one of: a number of questions or prominence of answers, said conforming comprises pruning said set of answers and questions to satisfy the criteria.

4. The computer-implemented method of claim 1, where said conforming comprises modifying said set of answers and questions to satisfy the criteria.

5. The computer-implemented method of claim 1, wherein said retrieving a set of documents from said initial set of questions comprises:
generating an input query to retrieve documents matching said query;
performing a query context analysis upon said input query to generate query terms;
conducting a search in said corpus, utilizing one of more searchable components of said query terms, to obtain passages potentially including candidate answers, all passages potentially including candidate answers being stored in a data storage device;
analyzing all retrieved passages and that passage's metadata, in a candidate answer generation module, to generate an output plurality of data structures including candidate answers based upon the analyzing;
performing, by each of a plurality of parallel operating modules, supporting passage retrieval operation upon the set of candidate answers, and for each candidate answer, traversing the said data corpus and the said data storage device to find those passages having candidate answer in addition to query terms.

6. The computer-implemented method of claim 5, further comprising:
automatically scoring all candidate answers using supporting passages by a plurality of scoring modules, each producing a module score;
applying a candidate answer ranking function to the said modules scores to determine one or more query answers; and,
generating a query response based on said one or more query answers for delivery to a user.

7. The computer-implemented method of claim 1, wherein said generating from a document, a candidate question and answer comprises:
receiving an input query, said input query comprising a string, a string with context, or a string with context wherein the context includes another string or data structure;
performing an automated query analysis including determining a lexical answer type; and,
automatically computing candidate answers to the input query using said corpus.

8. The computer-implemented method of claim 7, wherein said analyzing a quality of answers of said conformed set of questions and answers comprises:
computing one or more lexical answer types (LAT) for each candidate answer;
utilizing an automated scoring function to compare candidate answer lexical types to the query LAT and producing a score for each candidate answer; and,
returning one or more answers pared with a respective one or more questions based on the produced scores for delivery to a user.

9. The computer-implemented method of claim 1, wherein an initial question formed of a predicate has no corresponding uniquely determined answer, said method further comprising:
successively adding one or more additional predicates to ensure that the answer entity is uniquely determined by the predicate and the additional predicates.

10. The computer-implemented method of claim 1, further comprising:
automatically generating, for receipt by a first user via a first interface, questions and answers, a first user presenting a generated answer or question to a second user, to provide a respective responsive questions or answer, via a second interface.

11. A system for question-answer list generation comprising:
a memory device; and
a processor connected to the memory device, wherein the processor performs step of:
generating, from a corpus of text data and a set of criteria, one or more data structures;
generating, based on said set of criteria and one or more data structures, an initial set of questions;
retrieving a set of documents based on said initial set of questions;
generating from said documents, candidate question and answers;
conforming said set of candidate questions and answers to satisfy said set of criteria;
analyzing a quality of answers of said conformed set of questions and answers;
generating further one or more answers based on said analyzing; and, outputting, based on said further one or more answers and said criteria, a final list question-answer (QA) pairs.

12. The system of claim 11, wherein said generating a candidate question and answer from said documents comprises:
generating, from said set of documents, predicate-argument sets; and
converting said predicate/argument sets of into a set of candidate questions and answers, an answer being one or more arguments of a predicate and the question being a transformation of the predicate and remaining arguments.

13. The system of claim 11, where said criteria includes one of: a number of questions or prominence of answers, said conforming comprises pruning or modifying said set of answers and questions to satisfy the criteria.

14. The system of claim 11, wherein said retrieving a set of documents from said initial set of questions comprises:
generating an input query to retrieve documents matching said query;
performing a query context analysis upon said input query to generate query terms;
conducting a search in said corpus, utilizing one of more searchable components of said query terms, to obtain passages potentially including candidate answers, all passages potentially including candidate answers being stored in a data storage device;
analyzing all retrieved passages and that passage's metadata, in a candidate answer generation module, to generate an output plurality of data structures including candidate answers based upon the analyzing;
performing, by each of a plurality of parallel operating modules, supporting passage retrieval operation upon the set of candidate answers, and for each candidate answer, traversing the said data corpus and the said data storage device to find those passages having candidate answer in addition to query terms.

15. The system of claim 14, further comprising:
automatically scoring all candidate answers using supporting passages by a plurality of scoring modules, each producing a module score;
applying a candidate answer ranking function to the said modules scores to determine one or more query answers; and,
generating a query response based on said one or more query answers for delivery to a user.

16. The system of claim 11, wherein said generating from each document, a candidate question and answer comprises:
receiving an input query, said input query comprising a string, a string with context, or a string with context wherein the context includes another string or data structure;
performing an automated query analysis including determining a lexical answer type; and,
automatically computing candidate answers to the input query using said corpus.

17. The system of claim 16, wherein said analyzing a quality of answers of said conformed set of questions and answers comprises:
computing one or more lexical answer types (LAT) for each candidate answer;
utilizing an automated scoring function to compare candidate answer lexical types to the query LAT and producing a score for each candidate answer; and,
returning one or more answers pared with a respective one or more questions based on the produced scores for delivery to a user.

18. The system of claim 11, wherein an initial question formed of a predicate has no corresponding uniquely determined answer, said processor further performing:
successively adding one or more additional predicates to ensure that the answer entity is uniquely determined by the predicate and the additional predicates.

19. The system of claim 11, further comprising:
automatically generating, for receipt by a first user via a first interface, questions and answers, a first user presenting a generated answer or question to a second user, to provide a respective responsive questions or answer, via a second interface.

20. A computer program product for question-answer list generation, the computer program product comprising:
a computer readable storage medium having computer readable program code embodied therewith, the computer readable program code comprising:
computer readable program code configured to generate, from a corpus of text data and a set of criteria, one or more data structures;
computer readable program code configured to generate, based on said set of criteria and one or more data structures, an initial set of questions;
computer readable program code configured to retrieve a set of documents based on said initial set of questions;
computer readable program code configured to generate from said documents, candidate question and answers;
computer readable program code configured to conform said set of candidate questions and answers to satisfy said set of criteria;
computer readable program code configured to analyze a quality of answers of said conformed set of questions and answers;
computer readable program code configured to generate further one or more answers based on said analyzing; and,
computer readable program code configured to output, based on said further one or more answers and said criteria, a final list question-answer (QA) pairs.

21. The computer program product of claim 20, wherein said generating a candidate question and answer from said documents comprises:
generating, from said set of documents, predicate-argument sets; and
converting said predicate/argument sets of into a set of candidate questions and answers, an answer being one or more arguments of a predicate and the question being a transformation of the predicate and remaining arguments.

22. The computer program product of claim 11, where said criteria includes one of: a number of questions or prominence of answers, said conforming comprises pruning or modifying said set of answers and questions to satisfy the criteria.

23. The computer program product of claim 11, wherein said retrieving a set of documents from said initial set of questions comprises:
generating an input query to retrieve documents matching said query;
performing a query context analysis upon said input query to generate query terms;
conducting a search in said corpus, utilizing one of more searchable components of said query terms, to obtain passages potentially including candidate answers, all passages potentially including candidate answers being stored in a data storage device;
analyzing all retrieved passages and that passage's metadata, in a candidate answer generation module, to generate an output plurality of data structures including candidate answers based upon the analyzing;
performing, by each of a plurality of parallel operating modules, supporting passage retrieval operation upon the set of candidate answers, and for each candidate answer, traversing the said data corpus and the said data storage device to find those passages having candidate answer in addition to query terms.

24. The computer program product of claim 23, further comprising:
automatically scoring all candidate answers using supporting passages by a plurality of scoring modules, each producing a module score;
applying a candidate answer ranking function to the said modules scores to determine one or more query answers; and,
generating a query response based on said one or more query answers for delivery to a user.

25. A question answering (QA) system comprising:
a memory device; and
a processor connected to the memory device, wherein the processor performs step of:
automatically preparing a list of question/answer pairs, each consisting of a question and an answer, said preparing comprising:
providing a plurality of word or phrases based on a criteria;
selecting, an entity from among said plurality of entity word or phrases;
retrieving one or more documents including said entity;
automatically creating a question by selecting a predicate in a document within which the entity appears, and successively adding additional predicates to ensure that the entity is uniquely determined by the predicate and any additional predicates; and,
setting the question to the predicate and the additional list of predicates retrieved, and setting the answer to the entity.

26. The question answering (QA) system according to claim 25, further comprising:
repeating, for each entity, said selecting a predicate and adding additional predicates, and formulating a respective answer for each said entity.

27. The question answering (QA) system according to claim 25, further comprising: ordering a resulting list of question/answer pairs based on an additional criteria.
